(19) United States
(12) Patent Application Publication
(10) Pub. No.: US 2006/0292373 A1
(43) Pub. Date: Dec. 28, 2006

(54) Elastomer molded article, rubber material and O-ring using same

(75) Inventors: Takeshi Kuboyama, Hamamatsu-shi (JP); Naoya Kuzawa, Hamamatsu-shi (JP)

Correspondence Address: OLIFF & BERRIDGE, PLC, P.O. BOX 19928, ALEXANDRIA, VA, 22320, US

(73) Assignee: NICHIAS CORPORATION, Tokyo (JP)

(21) Appl. No.: 11/475,030

(22) Filed: Jun. 27, 2006

(30) Foreign Application Priority Data
Jun. 27, 2005 (JP) 2005-185996

(51) Int. Cl. B32B 9/04

(52) U.S. Cl. 428/411.1

(57) ABSTRACT

A film of a fluorine-type resin having a thickness of 500 μm or less is formed on a surface of an elastomer molded article by a vacuum deposition method. The resultant elastomer molded article having the film of the fluorine-type resin has a sticking force to a metal of 100 N or less in an environment of from 200° C. to 300° C. and has a weight reduction ratio of 1.0% by weight or less by irradiation of a mixed plasma containing oxygen and carbon tetrafluoride.

### BACKGROUND OF THE INVENTION

1. Field of the Invention

The present invention relates to an elastomer molded article having improved surface characteristics, particularly, an elastomer molded article suitable for a semiconductor manufacturing apparatus, a semiconductor conveyance apparatus, a liquid crystal manufacturing apparatus and the like.

2. Disclosure of the Related Art

Conventionally, a seal material such as an O-ring used in a semiconductor manufacturing apparatus, a liquid crystal manufacturing apparatus or the like is required to have plasma resistance, heat resistance, cleanness, a non-sticking property, chemical resistance and the like. Therefore, perfluoro-type and fluorine-type rubber materials excellent in the plasma resistance, the heat resistance, and the chemical resistance and the like have frequently been used.

Ordinarily, since any one of the rubber materials often sticks to a metal surface to be sealed, a problem of inhibiting a normal operation of an apparatus and the like is apt to be generated in the apparatus in which opening and closing are frequently performed. At the time of maintenance, the seal material adheres to the metal surface so strongly that it can not easily be peeled off. When it is forcibly peeled off, there is a problem in that rubber powder fall by rubbing and, then, troubles with the apparatus is generated and the like. Such problem of sticking to the metal surface as described above similarly appears also in the fluorine-type rubber having a low surface energy. In particular, since the perfluoro-type rubber material has many opportunities to be exposed to vacuum or a high temperature, the problem of sticking to the metal surface becomes remarkable.

Accordingly, an effective technique for reducing a sticking property of the seal material, particularly, the fluorine-type rubber has been demanded. As for method for reducing the sticking property of the rubber material, there have conventionally been known methods of: blending an oil into rubber; forming a silicone reactive layer on a surface of a rubber material; blending a rubber material with silicone rubber; filling fluorocarbon resin powder or the like into rubber; irradiating a specific species of plasma on a rubber material; eliminating a low molecular substance from a rubber material; and the like.

However, in the method of blending the oil into the rubber material, there is a problem in that the oil exudes from the rubber material to cause contamination of the surroundings and, also, decreases strength of the material itself. In other methods, it is difficult to impart the non-sticking property to the perfluoro-type rubber materials and the fluorine-type rubber materials which are frequently used in a severe environment such as a high-temperature and vacuum environment.

Then, in JP-B No. 4-17217, a method for forming a thin film of a fluorine-type polymer on a surface of a rubber material by a sputtering method is proposed. Further, in JP-A No. 2004-137349, a method for forming a polymer layer of a fluorine-containing monomer on a surface of a rubber material by a plasma CVD (chemical vapor deposition) method is proposed. As is seen in these methods, the method for forming a film of a fluorine-type compound on the surface of the rubber material is extremely effective in imparting the non-sticking property to the rubber material.

However, with reference to the above-described conventional methods, there is a problem in any one of the sputtering method and the plasma CVD method in that treatment steps are complicated and cost of treating the apparatus is high. Further, there is a problem in that, in the sputtering method and the plasma CVD method, a surface of an elastomer molded article is apt to be damaged when the elastomer molded article is subjected to a surface treatment.

### SUMMARY OF THE INVENTION

Under these circumstances, the present invention has been achieved. An object of the invention is to provide an elastomer molded article in which a film of a fluorine-type resin is formed on a surface, and a rubber material and an O-ring using such elastomer molded article as described above.

In order to attain the above-described object, according to one aspect of the invention, there is provided an elastomer molded article which contains a film of a fluorine-type resin formed by a vacuum deposition method on a surface thereof.

Preferably, in the elastomer molded article, a sticking force to a metal is 100 N (Newton) or less in an environment of from 200° C to 300° C.

Preferably, in the elastomer molded article, a weight reduction ratio by irradiation of a mixed plasma containing oxygen and carbon tetrafluoride is 1.0% by weight or less.

Preferably, in the elastomer molded article, thickness of the film of the fluorine-type resin is 500 μm or less.

Preferably, in the elastomer molded article, an elastomer component is a perfluoroelastomer containing a copolymerization unit containing a perfluoroolefin, a perfluorovinyl ether selected from the group consisting of a perfluoro(alkyl vinyl) ether, a perfluoro(alkoxy vinyl) ether and a mixture thereof, and a cure site monomer.

Preferably, in the elastomer molded article, an elastomer component is a fluorine-type elastomer.

Preferably, in the elastomer molded article, a deposition material to be used in the vacuum deposition method is a fluorocarbon resin selected from the group consisting of polytetrafluoroethylene (PTFE), a tetrafluoroethylene perfluoroalkyl vinyl ether copolymer (PFA), a tetrafluoroethylene hexafluoropropylene copolymer (FEP) and mixtures thereof containing no hydrogen atom in a main chain.

According to another aspect of the invention, there is provided a rubber material for a semiconductor manufacturing apparatus, a semiconductor conveyance apparatus or a liquid crystal manufacturing apparatus containing the elastomer molded article according to the invention.

According to still another aspect of the invention, there is provided an O-ring, containing the elastomer molded article according to the invention.

### DESCRIPTION OF THE PREFERRED EMBODIMENTS

Hereinafter, the present invention is described in detail with reference to best modes for carrying out the invention (hereinafter, referred to also as “preferred embodiment”).

The present inventors have found that, when a film of a fluorocarbon resin is formed on a surface of an elastomer molded article by using a vacuum deposition method, not only the surface of the elastomer molded article is hardly damaged and, even when it contacts with a metal in a high-temperature environment, it exhibits a non-sticking property such that it does not stick to a surface of the metal, but also resistance thereof to a mixed plasma containing oxygen and carbon tetrafluoride is remarkably increased, to thereby achieve the present invention.

Specifically, when a film of a fluorine-type resin is formed on a surface of an elastomer molded article by using a vacuum deposition method, the elastomer molded article having a sticking force to a metal of 100 N (Newton) or less can be obtained, for example, in an environment of from 200 to 300° C. A weight reduction ratio of the elastomer molded article according to the preferred embodiment which has been subjected to such surface coating treatment as described above by irradiation of a mixed plasma containing oxygen and carbon tetrafluoride is 1.0% by weight or less. Further, the film of the fluorine-type resin preferably has a thickness of 500 μm or less. The reason is that, when the thickness of the film is over 500 μm, hardness of the surface of the elastomer molded article which has been subjected to a coating treatment is increased and, then, a sealing property is decreased. By allowing the thickness of the film to be 500 μm or less, it becomes possible to suppress an He leak amount to be 1.0×10⁻⁸ (Pa·m³/sec) or less.

In this occasion, since a glass transition temperature of the film of the fluorine-type resin to be formed on the surface of the elastomer molded article is extremely high compared with that of the elastomer, a molecular movement of a surface molecular chain of the elastomer molded article on which the film is formed is put under restraint and, then, flowing thereof into fine concave and convex of the metal surface is suppressed even in a high temperature. Further, since polarizability of the fluorine-type resin is small, a cohesive force between molecules thereof becomes small and, then, not only a surface having a low surface free energy is formed, but also it does not have an active group such as a hydroxyl group, a carbonyl group, or a carboxyl group. Accordingly, a hydrogen bonding action with the metal surface is suppressed, an excellent surface stability is maintained for a long period of time and, then, an elastomer molded article having the non-sticking property can be obtained. Further, since a bonding energy between carbon and fluorine is extremely large, the elastomer molded article excellent in plasma resistance can be obtained by forming the film of the fluorine-type resin.

Examples of elastomer components each constituting the elastomer molded article according to the preferred embodiment include a natural rubber, an isoprene rubber, a butadiene rubber, a styrene-butadiene rubber, a butyl rubber, a chloroprene rubber, a nitrile rubber, an ethylene-propylene rubber, an acrylic rubber, an epichlorohydrin rubber, Hypalon, a urethane rubber, a silicone rubber, a fluorocarbon rubber and a perfluoro rubber, but are not limited thereto. As for the perfluoro rubber, such perfluoro rubber as containing a copolymerization unit having a perfluoroolefin, a perfluorovinyl ether selected from the group consisting of a perfluoro(alkyl vinyl) ether, a perfluoro(alkoxy vinyl) ether and a mixture thereof, and a cure site monomer is preferred.

Further, the elastomer components each constituting the elastomer molded article according to the preferred embodiment also include cross-linked molded articles of such elastomers as described above. However, a cross-linking method is not particularly limited.

By forming the film of the fluorine-type resin by means of vacuum deposition on the elastomer molded article formed from such elastomer component as described above, the elastomer molded article according to the preferred embodiment which is excellent in the non-sticking property and the plasma resistance can be obtained.

On this occasion, from the standpoint of the non-sticking property and the plasma resistance, a vapor deposition material to be used for forming the film on the surface of the elastomer molded article is preferably a fluorocarbon resin having a low critical surface tension and a large bond dissociation energy and, more preferably, a fluorocarbon resin selected from the group consisting of polytetrafluoroethylene (PTFE), a tetrafluoroethylene perfluoroalkyl vinyl ether copolymer (PFA) and a tetrafluoroethylene hexafluoropropylene copolymer (FEP) and mixtures thereof having no hydrogen atom in a main chain.

A temperature condition of the above-described deposition material at the time of performing the vacuum deposition may be set to be a temperature of a boiling point or higher of the material. However, when it is abruptly over-heated, there is a possibility of bumping of the deposition material and, therefore, it is preferred that the temperature is raised at a relatively slow speed.

A degree of vacuum of an apparatus at the time of performing the vacuum deposition is preferably 1 Torr (133 Pa) or less and an optimal value thereof is appropriately set depending on the vacuum deposition apparatus and the deposition material. When the degree of vacuum becomes unduly low, ratios of a moisture, oxygen and dust to be present in a chamber in which the vacuum deposition is performed become high and, then, it becomes difficult to obtain a targeted deposition film. For this account, it is preferred to appropriately determine a lowest limit of the degree of vacuum.

A deposition time is preferably in the range of from 30 sec. to 10 min. The deposition time is directly related with thickness of the film to be formed on the surface of the elastomer molded article; however, as described above, in order to maintain the sealing property, it is necessary to set the thickness to be 500 μm or less and, therefore, the deposition time is appropriately controlled. The above-described film thickness can also be controlled by a volume of the deposition material to be charged.

When the elastomer molded article to be a base material is rotated at a low speed while the film is formed, uniformity of the film to be formed can be improved. On this occasion, such rotation speed is preferably in the range of from 5 to 600 rpm.

Since the film of the fluorine-type resin is formed on the surface of the elastomer molded article according to the preferred embodiment obtained in such manner as described above, the elastomer molded article is excellent not only in the heat resistance and the chemical resistance, but also in the non-sticking property and the plasma resistance. For this account, it is preferable as a constituting material for an apparatus such as a semiconductor manufacturing apparatus, a semiconductor conveyance apparatus, a food manufacturing apparatus, a food conveyance apparatus, a food storage apparatus, medical parts or a liquid crystal manufacturing apparatus to be used in a severe environment such as a high-temperature vacuum environment. For example, in a field of manufacture of the semiconductor, it can be used in the semiconductor manufacturing apparatus such as a wet rinsing apparatus, a plasma etching apparatus, a plasma ashing apparatus, a plasma CVD apparatus, an ion-injecting apparatus and a sputtering apparatus, as well as an ancillary apparatus thereof such as a wafer conveyance apparatus. As is described above, the elastomer molded article according to the preferred embodiment is preferably used as a rubber material, particularly, an O-ring for the semiconductor manufacturing apparatus, the semiconductor conveyance apparatus, liquid crystal manufacturing apparatus, the food manufacturing apparatus, the food conveyance apparatus or the food storage apparatus.

The present invention will be illustrated in greater detail with reference to the following Examples, but the invention should not be construed as being limited thereto.

### EXAMPLE 1

In an autoclave made of stainless steel having a holding capacity of 500 ml, 200 ml of distilled water, 2.5 g of ammonium perfluorooctanoate and 4.4 g of Na₂HPO₄. 12H₂O were charged and then, an inside of the autoclave was replaced with a nitrogen gas, followed by pressure reduction. After cooling this autoclave to 50° C., 32 g of tetrafluoroethylene, 68 g of perfluoromethyl vinyl ether and 6.4 g of perfluoro-8-cyano-5-methyl-3,6-dioxa-1-octene were charged therein and the temperature thereof was elevated to 80° C. Then, 0.75 g of sodium sulfite and 3.75 g of ammonium persulfate were each charged in the form of a 25-ml aqueous solution.

Thereafter, polymerization was initiated. After continuation of the polymerization for 20 hours, an unreacted gas was purged and, then, an aqueous latex formed at the bottom of the autoclave was taken out. Thereafter, the thus-taken out aqueous latex has been subjected to a salting-out treatment using a 10% aqueous solution of sodium chloride, followed by drying, to thereby obtain 44 g of a ternary copolymer in a crumb rubber state. From the results of infrared absorption analysis, it was confirmed that this ternary copolymer had a copolymerization composition of 62% by mol of tetrafluoroethylene, 37% by mol of perfluoromethyl vinyl ether and 1.0% by mol of perfluoro-8-cyano-5-methyl-3,6-dioxa-1-octene.

Next, a perfluoroelastomer was obtained in the procedures as described below by using the ternary copolymer.

Blending Composition:

ternary copolymer (100 parts);

2,2′-bis(3-amino-4-hydroxyphenyl)hexafluoropropane (1 part);

dicyclohexyl-18-crown-6 (2 parts);

zinc white (2 parts); and

MT carbon (20 parts).

After the blending composition was kneaded by using an open roll, it was primarily cross-linked by being subjected to a thermal treatment at 190° C. for 20 minutes and, then, secondarily cross-linked by being subjected to a thermal treatment at 240° C. for 48 hours, to thereby obtain a perfluoroelastomer molded article.

The thus-obtained perfluoroelastomer molded article and PTFE in bulk which is a deposition material were set in a chamber of a vacuum deposition apparatus and, then, the temperature of the deposition material was elevated to 800° C. consuming 10 minutes under the conditions that the degree of vacuum was 1.0×10⁻⁵ Torr (1.33×10⁻³ Pa), the substrate temperature was 200° C., and revolution of the substrate stage was 60 rpm, to allow PTFE to be deposited for 2 minutes until it was completely evaporated from a crucible.

With reference to the thus-obtained perfluoroelastomer molded article according to the preferred embodiment which has been subjected to a film-forming treatment of PTFE which is a fluorine-type resin, a sticking test, a plasma exposure test, and a helium leak test were conducted. As Comparative Example, a perfluoroelastomer molded article which has not been subjected to the film-forming treatment has been subjected to same tests as those described above. The results of these tests are shown in Table 1. In Table 1, the perfluoroelastomer molded article according to the preferred embodiment is denoted as “with film” and Comparative Example was denoted as “without film”. The result of the sticking test is denoted as “sticking force” and the result of the plasma exposure test is denoted as “weight reduction ratio” and the result of the helium leak test is denoted as “helium leak amount”.

TABLE 1

| | Sticking force (N) | | Weight | Helium leak |
|---|---|---|---|---|
| | | A5052 | reduction ratio | amount |
| | SUS316L | alumite | (% by weight) | (Pa · m³/sec) |
| With film | 50 | 41 | 0.10 | 8.5 × 10⁻¹¹ |
| Without film | 310 | 280 | 0.10 | 3.0 × 10⁻¹² |
| (Comparative | | | | |
| Example) | | | | |

As shown in Table 1, in a case of the perfluoroelastomer molded article in which the film of PTFE according to the preferred embodiment is formed, the sticking force was about one sixth of that of perfluoroelastomer molded article which has not been subjected to film formation (Comparative Example). Therefore, it is found that the non-sticking property to the metal has been improved. Further, it is found that, in the plasma exposure test, there is no changes in the weight reduction ratio and, in the perfluoroelastomer molded article according to the preferred embodiment, favorable plasma resistance is maintained. Still further, in the helium leak test, a helium leak amount of the perfluoroelastomer molded article according to the preferred embodiment was almost equal to that of Comparative Example.

Now, various types of tests are explained

(Sticking test method)

A perfluoroelastomer molded article having a thickness of 6 mm and a diameter of 10 mm was prepared and was compressed by 25% in a thickness direction from both sides by being sandwiched with compression plates made of stainless steel (SUS316L) or those made of aluminum (A5052 alumite) each in disk form having a thickness of 2mm and a diameter of 90 mm. Such composite as described above was put as it was in a gear oven at 200° C. for 22 hours and left to stand. After cooled down, the compression plates made of the metal were vertically pulled up by using an autograph at a speed of 10 mm/sec, to thereby measure a maximum load at that time.

(Plasma exposure test)

A plasma exposure test was performed on a test piece under the conditions described below, weight reduction ratio of the test piece between before and after the tests was measured, to thereby evaluate the plasma resistance.

Plasma Exposure Conditions:

plasma generating apparatus: surface wave plasma etching apparatus manufactured by SHINKO SEIKI CO., LTD.;

specimen sizes: 20 mm×20 mm×2 mm thick;

etching gas: O₂/CF₄ (2000/200 ml/min);

processing pressure: 133 Pa;

power consumption: 3000 W;

plasma exposure time: 2 hours;

weight reduction ratio (% by wt)=(weight of test piece before exposure to plasma-weight of test piece after exposure to plasma)/(weight of test piece before exposure to plasma)×100.

(Helium leak test)

A leak amount was measured one minute after helium was allowed to flow by using a Helium leak detector UL500 manufactured by LEYBOLD, to thereby evaluate wettability of an interface of a metal or the like.

### EXAMPLE 2

In an autoclave made of stainless steel having a holding capacity of 100 ml, 40 g of ion-exchanged water, 5 g of tert. butanol, 0.5 g of C₈F₁₇COONH₄, 1.0 g of Na₂HPO₄. 12H₂O and 0.1 g of NaOH were charged and, then, 0.5 g of ammonium persulfate dissolved in a small amount of water was added therein. After an inside of the autoclave was cooled with liquid nitrogen, a previously prepared aqueous solution in which 0.0075 g of FeSO₄. 7H₂O, 0.009 g of EDTA (ethylene diamine tetraacetic acid disodium salt.2H₂O; hereinafter, same is applied) and 0.04 g of CH₂(OH)SO₂Na were dissolved in 5 g of water was added and the inside of the autoclave was deaired. The resultant catalyst-containing aqueous medium had a pH value of 9.1.

Next, 8.2 g of a mixed gas containing tetrafluoroethylene and propylene in which a molar ratio of C₂F₄/C₃H₆ was adjusted to be 85/15 was charged in the autoclave and, then, the autoclave was put in a thermostatic oven having a temperature of 25° C. and a copolymerization reaction was performed while shaking the autoclave. As a result, fluororubber latex which is a propylene·tetrafluoroethylene copolymer with a molar ratio of C₂F₄/C₃H₆ being 45/55 and a molecular weight of 13.3×10⁴ was obtained at a copolymerization reaction speed of 120 g/l·hour.

An aqueous ammonium acetate solution (concentrateion: 10% by weight) having 5 times as much volume as the fluororubber latex has was charged in a coagulation tank and, then, the fluororubber latex was added thereinto in drops at an appropriate speed while being stirred. By these procedures, the fluororubber latex was coagulate-separated. The thus-coagulate-separated rubber-like product was rinsed with water and dried, to thereby obtain crude rubber.

Further, the thus-obtained crude rubber was heat-pressed at 150° C., to thereby prepare a preliminary sheet of 100 mm×100 mm×6 mm thick. The thus-prepared sheet was irradiated with a gamma ray with a radiation dosage of 80 kGy in a nitrogen gas atmosphere to allow it to be cross-linked and, as a result, a cross-linked molded article (fluorine-type elastomer molded article) was obtained.

The thus-obtained fluorine-type elastomer molded article has been subjected to the film-forming treatment of PTFE by vacuum deposition in a same manner as in Example 1.

On the thus-obtained fluorine-type elastomer molded article subjected to the film-forming treatment of the fluorocarbon resin (PTFE), the sticking test, the plasma exposure test and the helium leak test were performed. Further, the fluorine-type elastomer which has not been subjected to the film-forming treatment has been subjected to these tests in a same manner as Comparative Example. These test results are shown in Table 2.

TABLE 2

| | Sticking force (N) | | Weight | Helium leak |
|---|---|---|---|---|
| | | A5052 | reduction ratio | amount |
| | SUS316L | alumite | (% by weight) | (Pa · m³/sec) |
| With film | 35 | 34 | 7.6 | 7.1 × 10⁻¹¹ |
| Without film | 170 | 155 | 28.0 | 1.0 × 10⁻¹² |
| (Comparative | | | | |
| Example) | | | | |

As shown in Table 2, in a case of the perfluoroelastomer molded article which has been subjected to the film-forming treatment of the fluorine-type resin, the sticking force was about one fifth of that of the perfluoroelastomer molded article which has not been subjected to film formation (Comparative Example) . Therefore, it is found that the non-sticking property has been improved. Further, it is found that, in the plasma exposure test, the weight reduction ratio of the perfluoroelastomer molded article which has been subjected to the film-forming treatment of the fluorine-type resin was as small as about one fourth of that of Comparative Example. Still further, in the helium leak test, a helium leak amount of the perfluoroelastomer molded article which has been subjected to the film-forming treatment of the fluorine-type resin had almost no change from that of Comparative Example.

What is claimed is:

1. An elastomer molded article, comprising a film of a fluorine-type resin formed by a vacuum deposition method on a surface thereof.

2. The elastomer molded article according to claim 1, wherein a sticking force to a metal is 100 N (Newton) or less in an environment of from 200° C. to 300° C.

3. The elastomer molded article according to claim 1, wherein a weight reduction ratio by irradiation of a mixed plasma comprising oxygen and carbon tetrafluoride is 1.0% by weight or less.

4. The elastomer molded article according to claim 1, wherein thickness of the film of the fluorine-type resin is 500 μm or less.

5. The elastomer molded article according to claim 1, wherein an elastomer component is a perfluoroelastomer containing a copolymerization unit comprising a perfluoroolefin, a perfluorovinyl ether selected from the group consisting of a perfluoro(alkyl vinyl) ether, a perfluoro(alkoxy vinyl) ether and a mixture thereof, and a cure site monomer.

6. The elastomer molded article according to claim 1, wherein an elastomer component is a fluorine-type elastomer.

7. The elastomer molded article according to claim 1, wherein a deposition material to be used in the vacuum deposition method is a fluorocarbon resin selected from the group consisting of polytetrafluoroethylene (PTFE), a tetrafluoroethylene perfluoroalkyl vinyl ether copolymer, a tetrafluoroethylene hexafluoropropylene copolymer (FEP) and mixtures thereof containing no hydrogen atom in a main chain.

8. A rubber material for a semiconductor manufacturing apparatus, a semiconductor conveyance apparatus or a liquid crystal manufacturing apparatus comprising the elastomer molded article according to claim 1.

9. An O-ring, comprising the elastomer molded article according to claim 1.
